(19) United States
(12) Patent Application Publication
(10) Pub. No.: US 2021/0371630 A1
(43) Pub. Date: Dec. 2, 2021

(54) LIGNIN-ENHANCED BUTYL RUBBERS

(71) Applicant: SUZANO CANADA INC., Burnaby (CA)

(72) Inventors: John Frank KADLA, Vancouver (CA); Linda BOTHA, North Vancouver (CA)

(21) Appl. No.: 17/366,996

(22) Filed: Jul. 2, 2021

Related U.S. Application Data
(63) Continuation of application No. PCT/CA2020/050004, filed on Jan. 2, 2020.
(60) Provisional application No. 62/788,428, filed on Jan. 4, 2019.

(51) Int. Cl. C08L 19/00; C08L 23/28; C08K 3/04; C08K 3/36; C08L 97/00; C08K 3/26

(52) U.S. Cl. CPC C08L 19/006; C08L 23/283; C08K 3/04; C08K 2003/265; C08L 97/005; C08K 3/26; C08K 3/36

(57) ABSTRACT

Halogenated butyl rubbers are provided comprising lignins and co-reinforcing agents, where the ratio of the lignin to the co-reinforcing agent is selected so as to effectively modulate advantageous properties of the vulcanizate. The advantageous properties are achieved when using a ratio of lignin to the co-reinforcing agent, such as carbon black or silica, that is higher than in a reference vulcanizate, in effect the substitution of lignin for conventional reinforcing agents improves the reinforcement of the vulcanizates.

This application is a continuation of PCT/CA2020/050004, filed Jan. 2, 2020; which claims the benefit of U.S. Provisional Application No. 62/788,428, filed Jan. 4, 2019. The contents of the above-identified applications are incorporated herein by reference in their entirety.

### TECHNICAL FIELD

Rubber formulations having enhanced vulcanizate properties are disclosed, comprising lignins derived from lignocellulosic feedstocks.

### BACKGROUND

Lignins are a heterogeneous class of complex cross-linked organic polymers. They form a relatively hydrophobic and aromatic phenylpropanoid complement to cellulose and hemicellulose in the structural components of vascular plants. Lignification is the final stage in plant cell wall development; lignin serving as the ‘adhesive’ consolidating the cell wall. As such native lignin has no universally defined structure. Native lignin is a complex macromolecule comprised of 3-primary monolignols (e.g. phenylpropane units; p-coumaryl alcohol, coniferyl alcohol and sinapyl alcohol) connected through a number of different carbon-carbon and carbon-oxygen linkages. The type of monolignol and inter-unit linkage vary depending on numerous factors including genetic and environmental factors, species, cell/growth type, and location within/between the cell wall.

Extracting lignin from lignocellulosic biomass generally results in lignin deconstruction/modification and generation of numerous lignin fragments of varying chemistry and macromolecular properties. Some processes used to remove lignin from biomass hydrolyse the lignin structure into lower molecular weight fragments with high amounts of phenolic hydroxyl groups thereby increasing their solubility in the processing liquor (e.g. sulphate lignins). Other processes not only deconstruct the lignin macromolecule, but also introduce new functional groups into the lignin structure to improve solubility and facilitate their removal (e.g. sulphite lignin). The generated lignin fragments are generally referred to as lignin derivatives and/or technical lignin. As it is quite difficult to elucidate and characterize such complex mixtures of molecules and macromolecules, lignin derivatives are usually described in terms of the lignocellulosic plant material used, and the methods by-which they are produced and recovered from, i.e. lignin isolated from the Kraft pulping of a softwood species are referred to as softwood Kraft lignin. Likewise, the organosolv pulping of an annual fibre generates an annual fibre organosolv lignin, etc. (see for example U.S. Pat. Nos. 4,100,016; 7,465,791; and PCT Publication No. WO 2012/000093, (A. L. Macfarlane, M. Mai et al., 20-Bio-based chemicals from biorefining: lignin conversion and utilisation, 2014).

Despite lignins being among the most abundant natural polymers on earth (A. L. Macfarlane, M. Mai et al., 20-Bio-based chemicals from biorefining: lignin conversion and utilisation, 2014), the large-scale commercial use of extracted lignin derivatives isolated from traditional pulping processes used in the manufacture of pulp for paper manufacturing has been limited. This is due not only to the important role lignins and lignin-containing processing liquors play in process chemical/energy recovery, but also due to the inherent inconsistencies in their chemical and physical properties. These inconsistencies can arise due to numerous factors, such as changes in biomass supply (region/time of year/climate) and the particular extraction/generation/recovery conditions employed, which are further complicated by the inherent complexities in the chemical/molecular structures of the biomass itself.

Notwithstanding their complexity, lignins continue to be evaluated for a variety of thermoplastic, thermoset, elastomer and carbonaceous materials. For example, softwood Kraft lignin has been shown to be an effective substitute component in many adhesive systems (phenol-formaldehyde, polyurethane and epoxy resins), rubber materials, polyolefins and carbon fibres (T. Q. Hu, Chemical Modification, Properties, and Usage of Lignin, 2002) (A. L. Macfarlane, M. Mai et al., 20-Bio-based chemicals from biorefining: lignin conversion and utilisation, 2014).

Reinforcing fillers are often used to improve the mechanical strength and stiffness of elastomers. Carbon black or silica are, for example, used as reinforcing fillers. Silica is frequently used with additives, such as organosilane compatibilizers, to improve its performance as a reinforcing agent. A number of studies investigating the use of lignin in a variety of distinctive rubber formulations have been published (Kosikova et al., 2007; Kosikova et al., 2005; Ikeda et al., 2017; Botros et al., 2016; U.S. Pat. Nos. 2,608,537, 2,906,718, 3,991,022, US20100204368A1, WO2014016344A1, WO2014097108A1, WO2015056758A1, WO2017109672A1, U.S. Pat. Nos. 4,477,612, 7,064,171, 8,664,305; US20110073229).

In various rubbers, lignin additives have been described as deleterious to some mechanical properties (such as tensile strength and modulus) compared to the standard additives, such as carbon blacks. For example, WO2009145784 describes a reduction in the 100% and 300% modulus when lignin partially replaced carcass grade carbon blacks. Similarly, Setua et al., 2000 described the use of Kraft lignin in nitrile rubber compounds and found that the elongation, hardness and compression set properties of lignin were similar to that of a phenolic resin, but inferior to carbon black. The tensile strength with unmodified and modified lignin was about 10% of that obtained for carbon black and the modulus at 100% elongation was about 50% lower than that obtained with carbon black.

Various methods of improving the performance of lignin in rubber formulations have been disclosed, such as the co-precipitation of lignin with the rubber latex, chemical modification/functionalization of the lignin (e.g. silylation or esterification) to improve lignin-rubber interactions, or a combination of these methods. For example, in WO2017109672 the delta torque, tensile strength, % elongation and 300% modulus were lower for a natural rubber compound containing a softwood Kraft lignin when incorporated by direct mixing, compared to co-precipitation. In the case of co-precipitation, even though the mechanical properties were improved above that of the unfilled rubber, relative to dry mixing of lignin, the modulus, abrasion resistance and hardness of lignin-reinforced vulcanizates were still not sufficient relative to compounds containing carbon black (Kakroodi & Sain, 2016). It has been suggested that co-precipitation combined with chemical modification is necessary to improve the mechanical properties of lignin filled rubbers (U.S. Pat. No. 2,845,397, US20100204368).

In addition to reduced filler dispersion and compatibility with the rubber matrix, lignin has also been reported to reduce the effectivity of curing systems. Nando et al., (1980) showed that the decrease in mechanical properties of lignin filled natural rubber blends were due to reduced crosslinking and that even though efficient vulcanization systems were less affected than conventional vulcanization systems, the total crosslink density (determined by solvent swelling) in the presence of lignin was still lower in all cases. Others have also reported a reduction in crosslinking of rubber compounds containing lignin, e.g. lignosulfonates in NR and SBR compounds (Kumaran et al., 1978 and Kumaran & De, 1978).

Butyl rubber (IIR) is a synthetic copolymer of isobutylene (typically 98-99%) and isoprene (typically 1-2%), poly(isobutene-co-isoprene), characterized by very low unsaturation content, and having distinct chemical and physical properties, such as gas impermeability and chemical resistance (see U.S. Pat. Nos. 2,356,128, 3,816,371, 3,775,387). Halogenated butyl rubber (XIIR), particularly in chlorinated (chlorobutyl, CIIR) and brominated (bromobutyl, BIIR) variants, may provide particular advantages, such as higher cure rates relative to IIR. Halogenation of the isoprene units, introducing allylic C—Br or C—Cl bonds, facilitates the formation of a highly cure reactive elastomer with vulcanization chemistry that is fundamentally different from other elastomers that rely on the reactivity of allylic C—H bonds, halobutyl rubbers may for example be cured by ZnO alone, producing vulcanizates in the absence of sulfur. This distinct cure chemistry may for example facilitate co-vulcanization with other rubbers, such as natural rubber (NR) and styrene-butadiene rubber (U.S. Pat. Nos. 3,104,235, 3,091,603, 3,780,002, 3,968,076).

### SUMMARY

Halogenated butyl rubbers are provided comprising lignins and co-reinforcing agents, where the ratio of the lignin to the co-reinforcing agent is selected so as to effectively modulate advantageous properties of the vulcanizate. In effect, lignin is used to tune desired properties of a reinforced XIIR vulcanizate. Advantageous properties are achieved when using a ratio of lignin to the co-reinforcing agent that is higher than in a reference vulcanizate, in effect the substitution of lignin for conventional reinforcing agents is shown to demonstrably improve the reinforcement of the vulcanizates.

In a select embodiment, a lignin-reinforced vulcanizate is provide that comprises: an elastomer, such as a butyl or halobutyl rubber; a co-reinforcing agent, such as carbon black (e.g. N300 to N900 series) or silica (e.g. precipitated silica or amorphous silica); and, a lignin. The elastomer may for example comprise a synthetic halogenated poly(isobutene-co-isoprene) butyl rubber (XIIR), and the XIIR may for example be a copolymer of isobutylene (e.g. 95-99.5%) and isoprene (e.g. 0.5-5%). In select embodiments, the vulcanizate may be formulated by direct mixing of the lignin with the XIIR, without co-precipitation of the lignin with the XIIR.

The co-reinforcing agent may be provided in a co-reinforcing concentration that increases the tensile strength of the vulcanizate compared to a reference vulcanizate that lacks the co-reinforcing agent in the co-reinforcing concentration. The reference vulcanizate optionally also includes lignin, generally in an amount so that the ratio of the lignin to the reinforcing agent is higher in the vulcanizate than in the reference vulcanizate. The increased proportion of lignin in the vulcanizate is accordingly associated with comparatively advantageous properties compared to the reference vulcanizate with a lower proportion of lignin. In select embodiments, the lignin and co-reinforcing agent are present in amounts such that the resulting vulcanizate is characterized by improved characteristics compared to a reference vulcanizate that lacks the lignin but includes an approximately equivalent concentration of the co-reinforcing agent. The co-reinforcing agent may for example include carbon black or silica or mixtures thereof. The co-reinforcing agent may for example making up from 10-80 parts per hundred rubber (“phr”).

The lignin may be provided in a lignin concentration that increases crosslinking in the vulcanizate, and may also: increase one or more of the tensile strength, elongation at break, a tensile modulus (e.g. 50% tensile modulus, 100% tensile modulus, 200% tensile modulus, or 300% tensile modulus), or crack growth resistance; and/or, decrease air permeability of the vulcanizate (for example compared to the reference vulcanizate). The ratio of the lignin to the reinforcing agent may for example be higher in the vulcanizate than in the reference vulcanizate, where the reference vulcanizate is the same material for purposes of comparisons between the effects of the co-reinforcing agent and the lignin, as described above. In effect, the reference vulcanizate must always have an equal or lower concentration of co-reinforcing agent than the vulcanizate, and the proportion of lignin to co-reinforcing agent in the vulcanizate must always be higher than the proportion of lignin to co-reinforcing agent in the reference vulcanizate. The co-reinforcing agent is accordingly present in an amount that provides for increased reinforcement, and lignin is present in a proportion that provides improved characteristics compared to a lower proportion of lignin to co-reinforcing agent. In one embodiment, where the concentration of the co-reinforcing agent is equal in the vulcanizate and the reference vulcanizate, the claimed vulcanizate will accordingly be characterized by the fact that the addition of lignin enhances important characteristics of the vulcanizate, including tensile strength.

The lignin may for example make up from 1-40 phr. The vulcanizate may be characterized by the presence of a phenolic component, and the lignin may constitute a significant proportion, or substantially all, of the phenolic component of the vulcanizate.

The vulcanizate may further include a filler, for example calcium carbonate, kaolin clay, talc, barite, or diatomite.

The lignin may for example be produced by a process comprising: solvent extraction of finely ground wood; acidic dioxane extraction of wood; biomass pre-treatment using steam explosion, dilute acid hydrolysis, ammonia fibre expansion, or autohydrolysis; pulping of lignocellulosics by Kraft pulping, soda pulping, sulphite pulping, ethanol/solvent pulping, alkaline sulphite anthraquinone methanol pulping, methanol pulping followed by methanol NaOH and anthraquinone pulping, acetic acid/hydrochloric acid or formic acid pulping, or high-boiling solvent pulping. The lignin may for example be provided as a powder or in a pelletized form (e.g. about 1-20 mm in diameter on average; or about 2-15 mm, about 3-10 mm; or ovoid with the large dimension up to about 10 mm, about 15 mm or about 20 mm, and the small dimension up to about 1 mm, about 5 mm or about 10 mm).

### DETAILED DESCRIPTION

Halogenated butyl rubbers (XIIRs) for use in the present formulations may comprise copolymers of isobutylene (for example 95-99.5 weight percent, or 98-99 wt %) and isoprene (for example 0.5-5 wt %, 0.3-6 wt % or 1-2 wt %, see Kruzelak & Hudec, 2018, Rubber Chem & Technology, 91 (1) 167-183). Chlorobutyl XIIRs may for example contain chlorine in an amount of from about 0.1 to about 6 wt %, or from about 0.8 to about 1.5 wt %. Bromobutyl XIIRs may for example contain bromine in an amount of from about 0.1 to about 15 wt %, or from about 1 to about 6 wt %. In halogenated butyl rubbers, the halogen content is limited by the isoprene content, and further limited by the characteristic that, in general, only a portion of the double bonds are halogenated, typically about 60%. Butyl rubber is typically produced by the cationic copolymerization of isobutylene with isoprene in the presence of a Friedel-Crafts catalyst at low temperature, for example around −100° C. or −90° C. The halogenated butyl rubber may then be produced, for example, by reacting a hexane solution of butyl rubber with elemental bromine or chlorine (K. Matyjaszewski, Cationic Polymerizations: Mechanisms, Synthesis & Applications, 1996).

The reinforced halogenated butyl rubber provided herein may be prepared by a wide range of methods, as for example described in ASTM D3958 and ASTM D3182. The XIIR may for example be mixed with lignins and co-reinforcing agents, such as carbon black and/or silica, on masticating equipment such as a rubber mill. Alternatively, the XIIR may be dissolved in a solvent, such as cyclohexane, and reinforcing agents added to the solution followed by mixing.

Carbon blacks for use in the reinforced XIIR may for example be of a grade designated according to ASTM D 1765 as N300 to N900 series, or specifically N650, N375, N347, N339, N330 (alternatively including others, such as N220 or N110).

Suitable amounts of carbon black or silica which may be used as reinforcing agents are from about 5 to about 70 parts per hundred rubber (phr), or from about 30 to about 50 phr.

Formulations may include cure activators or dispersing agents such as stearic acid (as exemplified), as well other processing aids such as, for example, naphthenic oil. A processing aid, emulsifier or dispersing agent may for example be an ammonium or alkali metal salt of C₁₂₋₂₄ fatty acids, such as ammonium, sodium or potassium salts of oleic acid, palmitic acid, stearic acid or linoleic acid. Alternative dispersing agents include ammonium and alkali metal salts of polyethoxylated sulfates of C₆₋₂₀ alkyl alcohols, or polyethoxylated C₆₋₁₄ alkylphenoxy ethanols, and acid esters (phthalic, adipinic, phosphoric, for example at loadings of 5-15 and 5-30 phr). Suitable amounts of the emulsifier may for example be from about 0.1 to about 15 phr, or from about 0.1 to about 5 phr.

Reinforced XIIRs may be formulated with the assistance of vulcanization reactants, activators, catalysts or accelerators, such as ZnO and/or sulfur and/or accelerator activators and/or sulfur donor/accelerators, such as: thiazoles, sulfenamides, guanidines, dithiocarbamates and thiuram sulfides; for example, thiocarbamamyls, dithiocarbamyls, alkoxythio carbonyls, dialkylthio phosphoryls, diamino-2,4,6-triazinyls, thiurams xanthates, and/or alkylphenols. A select thiazole is 2,2-dibenzothiazyl disulfide (MBTS) and a select thiuram is tetramethyl thiuram monosulfide (TMTM). A select alkylphenol is poly-tert-amylphenoldisulfide. When used, suitable accelerators may for example be added in an amount of from about 0.1 to about 10 phr, or from about 0.1 to about 5 phr.

A wide variety of derivatives of native lignin may be used in alternative embodiments, particularly lignins recovered during or after pulping of lignocellulosic feedstocks. The lignocellulosic feedstock may for example include hardwoods, softwoods, annual fibres, and combinations thereof. The lignin may for example be produced by a process comprising: solvent extraction of finely ground wood; acidic dioxane extraction of wood; biomass pre-treatment using steam explosion, dilute acid hydrolysis, ammonia fibre expansion, or autohydrolysis; pulping of lignocellulosics by Kraft pulping, soda pulping, sulphite pulping, ethanol/solvent pulping, alkaline sulphite anthraquinone methanol pulping, methanol pulping followed by methanol NaOH and anthraquinone pulping, acetic acid/hydrochloric acid or formic acid pulping, or high-boiling solvent pulping.

In some embodiments, formulations may achieve the desired properties while lacking added phenolic resins, such as resins of the kind used as reinforcing agents or tackifiers, or other crosslinking agents such as hexamine. Accordingly, where the vulcanizate comprises a phenolic component, the lignin may constitute substantially all of the phenolic component of the vulcanizate. Alternatively, the lignin may for example constitute at least about 45%, about 50%, about 55%, about 60%, about 65%, about &0%, about 75%, about 80%, about 85%, about 90%, about 95% or about 99% of the phenolic component of the vulcanizate, or any amount therebetween. In various embodiments, the lignin may constitute about 50% of the phenolic component of the vulcanizate. In other embodiments, the lignin may constitute about 75% to about 99% of the phenolic component of the vulcanizate, or any amount therebetween.

In various embodiments, moisture content may have an impact on lignin-containing vulcanizate performance. For example, increasing moisture content of the lignin in the vulcanizate may improve tensile properties, such as, for example, improve compound stiffness. The moisture content of the lignin may be between 0 wt % and about 300 wt % or any content therebetween. In various embodiments, the moisture content of the lignin may be between about 3 wt % and about 100 wt %, or any amount therebetween. In various embodiments, the moisture content of the lignin may be between about 10 wt % and about 50 wt % or any amount therebetween.

### EXAMPLES

The following Examples demonstrate characteristics of selected embodiments, illustrating for example that similar mechanical performance (equivalent tensile strengths and slightly increased tensile moduli) may be obtained in a lignin-reinforced XIIR, compared to exclusive use of a general purpose carbon black (N660) as a reinforcing agent, with partial carbon black replacement (<50%) with lignin in a simple BIIR system with a ZnO only cure. Surprisingly, when lignin replaces a higher reinforcing grade of carbon black (N330) in such formulations, the reinforcing effect is more pronounced. These characteristics illustrate the ability to tune the lignin-reinforced XIIR vulcanizates by adjusting the ratio of lignin to co-reinforcing agent.

In contrast to the effect in lignin-reinforced XIIR systems, when lignin is applied as a partial carbon black replacement in a simple NR system with a conventional sulfur cure, similar tensile strengths but increased % elongation (with a corresponding drop in tensile modulus) is obtained in the cured vulcanizates.

In a more complex BIIR/NR co-formulation, prepared with ZnO, sulfur donors and accelerators, the partial replacement of a reinforcing grade carbon black (N330) by lignin results in an unexpected enhancement of the vulcanizate properties, specifically a torque increase during curing, as well as the tensile modulus/stiffness. NMR and solvent swelling tests confirm a greater degree of crosslinking in the sample containing lignin, providing a mechanistic explanation for the empirically observed enhancement of selected vulcanizate properties.

The Examples further demonstrate that by making adjustments in the cure package of the complex BIIR/NR formulation, the properties of the vulcanizate containing lignin can be adjusted, or tuned, to significantly improve the crack growth performance of these compounds, relative to the control without lignin. It is also demonstrated that when lignin is present in selected amounts, the mechanical properties of the vulcanizate are maintained—even when the cure chemical loading is reduced to 50% of the original loading.

The following Examples further illustrate an additional avenue for tuning the properties of a lignin-containing XIIR vulcanizate, through the use of alternative lignins. By comparing the effect of different lignin types in a reinforced XIIR formulation, it is shown that different lignin types influence the performance to different extents. This illustrates that adaptations of lignin-reinforcing may be accomplished through the use of alternative lignins, without the requirement to chemically modify a particular lignin, for example by selecting a lignin evidencing greater reactivity in a particular formulation. For example, lignins may be selected based on the abundance of particular phenyl propanoid units, particularly the coniferyl alcohol, sinapyl alcohol and coumaryl alcohol units, which corresponds to guaiacyl (G), syringyl (S) and p-hydroxyphenyl (H) lignin structures.

The use of different physical forms of lignin are also exemplified, powder and pellets, demonstrating that similar or even slightly improved performance can be obtained when using pelletized lignin. This is significant because pelletized lignin may be a more practical option for dry/direct mixing in a commercial context, as it creates less dust which may be important from a health and safety perspective.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification are incorporated herein by reference as if each individual publication were specifically and individually indicated to be incorporated by reference herein and as though fully set forth herein. The invention includes all embodiments and variations substantially as hereinbefore described and with reference to the examples and drawings.

### Example 1

Lignin performance in BIIR with a ZnO cure

This example illustrates the performance of lignin in a standard bromobutyl rubber (BIIR) formulation with a simple ZnO cure. Rubber formulations were prepared according to ASTM D3958, with components shown in Table 1.

TABLE 1
BIIR Formulation with a ZnO cure containing
different lignin loadings and carbon black types

| Compound | A | B | C | D | E | F | G | H | I |
|---|---|---|---|---|---|---|---|---|---|
| Bromobutyl | 100 | 100 | 100 | 100 | 100 | 100 | 100 | 100 | 100 |
| (X_Butyl | | | | | | | | | |
| BB_2030) | | | | | | | | | |
| N660 | 40 | 32 | 30 | 24 | 20 | 10 | — | — | — |
| N330 | — | — | — | — | — | — | 40 | 30 | 30 |
| Stearic acid | 1 | 1 | 1 | 1 | 1 | 1 | 1 | 1 | 1 |
| Lignin 1 | — | 8 | 10 | 16 | 20 | 30 | — | — | 10 |
| ZnO | 5 | 5 | 5 | 5 | 5 | 5 | 5 | 5 | 5 |

The exemplified formulations were processed according to ASTM D3182. Specifically, a 2-stage process was used involving an internal mixer and a standard two roll mill. The first stage of mixing (67° C. starting temperature) consisted of first charging the bromobutyl rubber (BIIR, X_Butyl™ BB2030, halogen content 1.80 wt %) to the internal mixer and ram down mixing for 30 seconds. The carbon black, lignin and stearic acid were then added, the ram lowered and mixed to an accumulative time of between 5-7 minutes. The batch was discharged at a temperature of 138° C. The batch was immediately passed through a standard laboratory mill three times, set at 0.25 in and 50° C. During the second stage of mixing, the ZnO was charged along with the masterbatch to the internal mixer and mixed until a temperature of 93° C. was reached. The batch was then discharged and immediately milled (50° C. and 0.032 in. opening) followed by a set of 4 passes through an opening of 0.25 in, folding the material back on itself and alternating the grain direction.

Table 2 shows that the partial replacement of carbon black by lignin has very little impact on the extent of rubber curing, albeit a slight plasticizing effect (lower minimum torque) and increase in delta torque being observed.

TABLE 2
Rheological data of BIIR with a ZnO cure

| Compound | A | B |
|---|---|---|
| Min Torque (ML), lbf-inch | 12.13 | 11.46 |
| Max Torque (MH), lbf-inch | 23.05 | 25.59 |
| Delta Torque | 10.92 | 14.13 |

There was little to no impact on the physical properties of the resulting vulcanizates containing lignin for replacements up to 40% of a carcass grade (N660) carbon black (Table 3, D). At higher lignin loadings, the mechanical properties generally decrease (Table 3, E), however based on the tensile moduli at 50-100% elongations, some measure of reinforcement is observed. (Table 3, A vs E). When lignin replaces a reinforcing/tread grade of carbon black (N330), a more significant increase in the tensile moduli is observed with lignin relative to control (Table 3, I vs G), with a corresponding decrease in the ultimate % elongation. This indicates that stiffer vulcanizates can be obtained with lignin, especially when replacing a reinforcing grade of carbon black. Furthermore, a comparative sample with similar carbon black content but without the lignin, has significantly lower tensile moduli (Table 3, H).

TABLE 3
Physical Properties of BIIR rubber cured using a ZnO system

| Compound | A | B | C | D | E | F | G | H | I |
|---|---|---|---|---|---|---|---|---|---|
| Tensile strength (psi) | 1269 | 1283 | 1237 | 1172 | 1009 | 862 | 1502 | 1420 | 1404 |
| Elongation at break (%) | 662 | 647 | 675 | 705 | 737 | 858 | 624 | 729 | 595 |
| 50% Modulus (psi) | 85 | 107 | 91 | 104 | 85 | 85 | 120 | 87 | 131 |
| 100% Modulus (psi) | 122 | 165 | 137 | 157 | 127 | 124 | 170 | 117 | 206 |
| 200% Modulus (psi) | 244 | 303 | 250 | 266 | 210 | 190 | 340 | 218 | 380 |
| 300% Modulus (psi) | 434 | 483 | 404 | 393 | 298 | 243 | 592 | 379 | 605 |

### Example 2

Lignin performance in NR compounds with a conventional sulfur cure

In this Example, standard natural rubber (NR) compounds were prepared according to the formulation in ASTM D3192 using the conditions described in Example 1 (as shown in Table 4).

TABLE 4
NR Formulation containing ZnO and a sulfur
vulcanization system (lignin replacing carbon black)

| Compound | J | K | L | M | N | O |
|---|---|---|---|---|---|---|
| RSS#3 | 100 | 100 | 100 | 100 | 100 | 100 |
| N660 | — | 50 | 37.5 | 37.5 | 25 | — |
| Stearic acid | 3 | 3 | 3 | 3 | 3 | 3 |
| Lignin 1 | — | — | — | 12.5 | 25 | 50 |
| ZnO | 5 | 5 | 5 | 5 | 5 | 5 |
| MBTS | 0.6 | 0.6 | 0.6 | 0.6 | 0.6 | 0.6 |
| Sulfur | 2.5 | 2.5 | 2.5 | 2.5 | 2.5 | 2.5 |

Comparison of the physical properties of these compounds (shown in Table 5) indicates a different effect of lignin on the mechanical properties for NR, compared to BIIR (Example 1). When lignin is present at 25% replacement of carbon black (Table 5, M), the tensile strength is similar to that of the control, however there is an increase in the ultimate % elongation, with a corresponding decrease in the tensile moduli. The tensile moduli is however higher than that of the unfilled rubber (Table 5, J) and the compound with equivalent carbon black loading (Table 5, L). At 50% replacement, the tensile strength and moduli are significantly lower than that of the control, however still higher than that of the unfilled rubber (Table 5, J). At 100% replacement, the tensile moduli up to 300% elongation are significantly higher than that of the unfilled rubber, however the tensile strength at break and ultimate % elongation are reduced.

TABLE 5
Physical properties of NR cured with a conventional sulfur (CV) system

| Compound | J | K | L | M | N | O |
|---|---|---|---|---|---|---|
| Tensile strength (psi) | 2821 | 3649 | 3933 | 3683 | 3222 | 2090 |
| Elongation at break (%) | 817 | 452 | 552 | 541 | 582 | 513 |
| 50% Modulus (psi) | 75 | 204 | 150 | 176 | 145 | 145 |
| 100% Modulus (psi) | 113 | 418 | 282 | 351 | 270 | 255 |
| 200% Modulus (psi) | 182 | 1141 | 747 | 835 | 616 | 523 |
| 300% Modulus (psi) | 269 | 2096 | 1461 | 1496 | 1074 | 861 |

### Example 3

Lignin performance in a BIIR/NR formulation with a semi-efficient cure

In this Example, the complementary effects of lignin in the respective BIIR and NR systems is demonstrated. A combined BIIR/NR system with a more complex cure package, including sulfur donors and accelerators, in addition to ZnO, were prepared (Table 6) and processed as per Example 1. However, in this Example, during the second stage of mixing, ZnO, TMTM, MBTS and Vultac 5 were charged along with the masterbatch to the internal mixer and mixed until a temperature of 93° C. was reached. The batch was then discharged and immediately milled (50° C. and 0.032 in. opening) followed by a set of 4 passes through an opening of 0.25 in, folding the material back on itself and alternating the grain direction.

Table 6 illustrates the composition of the different lignin compounds (Q and R), relative to the control (P). For compound Q, 20% of the N330 carbon black was replaced by lignin, whereas in compound R, 20% of the clay was replaced by lignin in addition to the carbon black replacement, resulting in a total lignin loading of 16 phr.

TABLE 6
BIIR/NR formulation containing ZnO and semi-efficient sulfur
vulcanization system (lignin replacing carbon black)

| Compound | P | Q | R |
|---|---|---|---|
| Bromobutyl BB2030 | 80 | 80 | 80 |
| RSS #3 | 20 | 20 | 20 |
| N330 | 40 | 32 | 32 |
| Soft Clay | 40 | 40 | 32 |
| Stearic acid | 1 | 1 | 1 |
| Napthtenic Oil | 10 | 10 | 10 |
| Lignin 1 | — | 8 | 16 |
| ZnO | 5 | 5 | 5 |
| TMTM | 0.25 | 0.25 | 0.25 |
| MBTS | 1.25 | 1.25 | 1.25 |
| Vultac 5 | 0.5 | 0.5 | 0.5 |

In this formulation, the curing process of the rubber vulcanizates were significantly affected. In contrast to the basic ASTM formulation, a significant increase in both the minimum and maximum torque, as well as the delta torque for the lignin samples (Q and R), was observed relative to the control without lignin (P) (Table 7). The minimum and maximum torque values were slightly higher for the higher lignin loading (R), however the torque difference was similar for the two different lignin loadings.

TABLE 7
Rheological data for BIIR/NR compounds with the
ZnO and semi-efficient sulfur cure system

| Compound | P | Q | R |
|---|---|---|---|
| Min Torque (ML), lbf-inch | 8.27 | 10.94 | 13.04 |
| Max Torque (MH), lbf-inch | 22.73 | 32.84 | 34.79 |
| Delta Torque | 14.46 | 21.9 | 21.8 |

Mechanical test data showed a significant increase in the stiffness (moduli) of the compounds (Q and R) at different strains, along with a slight reduction in the elongation (Table 8). The tensile strengths are however comparable to the vulcanizate without lignin (P) and full CB loading. Furthermore, the effect of increased stiffness was more pronounced as the strain increases up to 200% (Q) and 300% (R).

Both vulcanizates containing lignin (Q and R) have improved (lower) air permeability values than the control (P), which is beneficial for certain applications such as inner-liners. The double partial replacement of carbon black and clay (R), exemplified the best balance in terms of air impermeability and crack growth resistance within the limits of experimental variability. This illustrates that lignins can be substituted for both reinforcing fillers, such as carbon black and silica, and for non-reinforcing fillers, such as clays, in XIIR vulcanizates, while improving the air impermeability of the compound. Furthermore, as the density of lignin is significantly lower than that of clay (typically about half), this facilitates the production of light-weighting vulcanizates having improved properties.

TABLE 8
Physical Properties for BIIR/NR vulcanizates with the semi-efficient cure

| Compound | P | Q | R |
|---|---|---|---|
| Tensile strength (psi) | 1394 | 1441 | 1421 |
| Elongation at break (%) | 657 | 562 | 549 |
| 50% Modulus (psi) | 112 | 144 | 141 |
| 100% Modulus (psi) | 168 | 251 | 247 |
| 200% Modulus (psi) | 300 | 479 | 495 |
| 300% Modulus (psi) | 476 | 733 | 773 |
| Crack growth | 385 000 | 110 000 | 305 000 |
| (cycles to 0.5″ crack growth) | | | |
| Air permeability (L/m²*24 hr) | 0.100 | 0.0452 | 0.07035 |

TABLE 9
Crosslink densities for lignin compounds
produced with different rubber types and cure systems

| Compound | G | I | J | K | L | M | P | Q |
|---|---|---|---|---|---|---|---|---|
| Crosslink density | 0.83 | 1.09 | 3.44 | 6.37 | 5.09 | 5.23 | 1.46 | 2.30 |
| (× 10⁻⁵ mol/cm³) | | | | | | | | |

Crosslink densities were determined by solvent swelling in n-decane as described by Boonkerd et al. (2016). The crosslink density results support the observations for the tensile moduli. Comparing the crosslink densities (XLD) for the BIIR/ZnO compounds, a slight increase in the XLD in the presence of lignin (Table 9, I), was observed compared to the control (Table 9, G). For a NR/CV cure the 25% EKL replacement (Table 9, M) shows a slightly higher crosslink density than the corresponding sample with equivalent carbon black (Table 9, L) or unfilled sample (Table 9, J), but lower than that of the control (Table 9, K). In the formulation with an 80/20 BIIR/NR composition and with a sulfur donor, the crosslink densities are significantly increased in the presence of lignin (Table 9, Q vs P).

### Example 4

Effect of Rubber Composition on Properties

In this Example, the stiffness increase observed with lignin is shown to be unique to the specific combination of rubber types in the inner-liner formulation. Table 10 shows the comparative samples for formulations containing either 100 phr BIIR without lignin (S) or with lignin (T) or 100 phr NR without lignin (U) and with lignin (V). Comparing the tensile properties of these compounds relative to the specific inner-liner formulation containing 80 phr BIIR and 20 phr NR (Table 6, P and Q), it is evident that lignin does not provide a benefit in either of the 100 phr BIIR and 100 phr NR systems (Table 11). For the 100 phr BIIR system, the tensile properties obtained with lignin is the same as those without and for the 100 phr NR system, the tensile properties, particularly the stiffness, is reduced in the presence of lignin.

TABLE 10
Formulation containing a semi-efficient vulcanization
system with different rubber compositions)

| Compound | S | T | U | V |
|---|---|---|---|---|
| Bromobutyl BB2030 | 100 | 100 | | |
| RSS #3 | | | 100 | 100 |
| N330 | 40 | 32 | 40 | 32 |
| Soft Clay | 40 | 40 | 40 | 40 |
| Stearic acid | 1 | 1 | 1 | 1 |
| Napthtenic Oil | 10 | 10 | 10 | 10 |
| Lignin 1 (HKL) | | 8 | | 8 |
| ZnO | 5 | 5 | 5 | 5 |
| TMTM | 0.25 | 0.25 | 0.25 | 0.25 |
| MBTS | 1.25 | 1.25 | 1.25 | 1.25 |
| Vultac 5 | 0.5 | 0.5 | 0.5 | 0.5 |

TABLE 11
Effect of rubber composition on properties

| Compound | S | T | U | V |
|---|---|---|---|---|
| Tensile strength (psi) | 1475 | 1423 | 1108 | 851 |
| Elongation at break (%) | 704 | 669 | 485 | 469 |
| 50% Modulus (psi) | 164 | 148 | 87 | 75 |
| 100% Modulus (psi) | 229 | 231 | 146 | 123 |
| 200% Modulus (psi) | 382 | 393 | 328 | 269 |
| 300% Modulus (psi) | 575 | 571 | 572 | 461 |

### Example 5

Lignin Replacement of Additional Cure Components

The increased degree of crosslinking, tensile moduli and increase in delta torque, as disclosed in Example 3, is indicative of interactions between lignin and the cure system. To further illustrate the surprising performance of lignin in semi-efficient vulcanization systems, embodiments are exemplified in this Example with the removal/reduction of various cure chemicals, as shown in Table 12.

TABLE 12
Formulation containing semi-efficient vulcanization system
(lignin replacing carbon black and removal/reduction of cure chemicals)

| Compound | P | W | X | W1 | W1 + X |
|---|---|---|---|---|---|
| Bromobutyl BB2030 | 80 | 80 | 80 | 80 | 80 |
| RSS #3 | 20 | 20 | 20 | 20 | 20 |
| N330 | 40 | 32 | 32 | 32 | 32 |
| Soft Clay | 40 | 40 | 40 | 40 | 40 |
| Stearic acid | 1 | 1 | 1 | 1 | 1 |
| Napthtenic Oil | 10 | 10 | 10 | 10 | 10 |
| Lignin | | 8 | 8 | 8 | 8 |
| ZnO | 5 | 5 | 2.5 | 5 | 2.5 |
| TMTM | 0.25 | 0.25 | 0.25 | 0.25 | 0.25 |
| MBTS | 1.25 | 1.25 | 1.25 | 1.25 | 1.25 |
| Vultac 5 | 0.5 | — | 0.5 | 0.25 | 0.25 |

Comparing the rheological properties in Tables 13 and 14, the compounds X, W1 and W1+X achieved significantly higher maximum and delta torques than the control (P), even when up to about 50% of the curatives were removed. This illustrates a surprising role of lignin during the curing process. Complete removal of Vultac 5 (W), resulted in similar maximum torque but slightly lower delta torque. In all cases the minimum torque was higher with lignin.

TABLE 13
Rheological data

| Compound | P | W | X |
|---|---|---|---|
| Min Torque (ML)-lbf.in | 8.27 | 10.51 | 10.72 |
| Max Torque (MH)-lbf.in | 22.73 | 21.77 | 32.37 |
| Delta Torque-lbf.in | 14.46 | 11.26 | 21.65 |

TABLE 14
Rheological data collected using an MDR with 0.5° arc

| Compound | P | W1 | X | W1 +X |
|---|---|---|---|---|
| Min Torque (ML)-lbf.in | 1.21 | 1.24 | 1.26 | 1.32 |
| Max Torque (MH)-lbf.in | 3.48 | 3.91 | 4.79 | 4.12 |
| Delta Torque-lbf.in | 2.27 | 2.67 | 3.53 | 2.80 |

The mechanical properties of the vulcanizates are shown in Table 15. Note that even though compound W has a lower ultimate tensile strength than the control (P), its fatigue performance (crack growth resistance) is significantly improved, which is important for applications that require resilience e.g. inner-liners. In addition to the improved fatigue performance, compound W is also stiffer than compound P, for elongations up to 300%. This represents the most extreme case of a complete removal of the primary curative, i.e. the sulfur donor. Improved resistance to deformation (stiffness/tensile moduli) along with improved fatigue performance is a unique balance of properties achievable with the use of a lignin in combination with a co-reinforcing agent, as these two properties are normally inversely related. The air permeability of this compound is, however, significantly increased.

Furthermore, when lignin is present in the compounds, 50% of each of the cure chemicals could be removed without any negative effects on mechanical stiffness (Table 15-W1, X and W1+X). In fact, consistent with the delta torque increase, these compounds have superior tensile moduli compared to the control. While a 50% reduction in the ZnO loading (Table 15, X) doesn't improve crack growth performance or air permeability, the 50% reduction in the S-donor (Table 15, W1) significantly improves the crack growth resistance, while also improving the air permeability, compared to the compound without any S-donor (Table 15, W).

The combined reduction of S-donor and ZnO (W1+X) provides the best crack growth performance, while maintaining good air permeability. However, in this case the ultimate tensile strength is reduced to 77% of that of the original. The tensile moduli were however still higher for this lignin compound than for the control, with a corresponding decrease in the ultimate elongation, indicating a stiffer compound in the presence of lignin, with excellent crack growth resistance, even when both of the main curatives are reduced by 50%.

TABLE 15
Physical properties of compounds with reduced curatives loading

| Compound | P | W | W1 | X | W1 + X |
|---|---|---|---|---|---|
| Tensile strength (psi) | 1394 | 1061 | 1172 | 1433 | 1072 |
| Elongation at break (%) | 657 | 589 | 587 | 572 | 583 |
| 50% Modulus (psi) | 112 | 121 | 122 | 138 | 116 |
| 100% Modulus (psi) | 168 | 193 | 200 | 241 | 185 |
| 200% Modulus (psi) | 300 | 353 | 378 | 461 | 342 |
| 300% Modulus (psi) | 476 | 529 | 575 | 708 | 518 |
| Crack growth resistance | 385 000 | 550 000 | 590 000 | 193 333 | 786667 |
| (cycles to 0.5″ crack growth) | | | | | |
| Air permeability (L/m²*24 hr) | 0.100 | 0.3661 | 0.073 | 0.109 | 0.088 |

### Example 6

Effect of Lignin Type on a BIIR/NR Formulation with a Semi-Efficient Cure

Lignin composition can vary depending on the source (biomass) and extraction method. In this Example, the performance of different types of lignin in the BIIR/NR/semi efficient system (Table 16) is exemplified. The different lignin types are: hardwood kraft (HKL), North American softwood kraft (SKL 1), Organosolv lignin (OSL), lignosulfonate (LS) and sulfonated kraft lignin (SL). The samples were compounded and vulcanized as described above.

TABLE 16
Formulation containing semi-efficient vulcanization
system (different lignin types replacing carbon black)

| Compound | Y | Z | AA | BB | CC | DD |
|---|---|---|---|---|---|---|
| Bromobutyl BB2030 | 80 | 80 | 80 | 80 | 80 | 80 |
| RSS#3 | 20 | 20 | 20 | 20 | 20 | 20 |
| N330 | 40 | 32 | 32 | 32 | 32 | 32 |
| Soft Clay | 40 | 40 | 40 | 40 | 40 | 40 |
| Stearic acid | 1 | 1 | 1 | 1 | 1 | 1 |
| Napthtenic Oil | 10 | 10 | 10 | 10 | 10 | 10 |
| Lignin 1 (HKL) | | 8 | | | | |
| Lignin 2 (SKL1) | | | 8 | | | |
| Lignin 3 (OSL) | | | | 8 | | |
| Lignin 4 (LS) | | | | | 8 | |
| Lignin 5 (SL) | | | | | | 8 |
| ZnO | 5 | 5 | 5 | 5 | 5 | 5 |
| TMTM | 0.25 | 0.25 | 0.25 | 0.25 | 0.25 | 0.25 |
| MBTS | 1.25 | 1.25 | 1.25 | 1.25 | 1.25 | 1.25 |
| Vultac 5 | 0.5 | 0.5 | 0.5 | 0.5 | 0.5 | 0.5 |

The mechanical properties of these vulcanizates are shown in Table 17. The ultimate tensile strength and moduli are relatively comparable to that of the control, relative to the control, and slightly better in the presence of HKL (Z), and OSL (BB).

TABLE 17
Physical properties for BIIR/NR
vulcanizates with the semi-efficient cure system.

| Compound | Y | Z | AA | BB | CC | DD |
|---|---|---|---|---|---|---|
| Tensile strength (psi) | 1434 | 1466 | 1306 | 1386 | 1293 | 1192 |
| Elongation at break (%) | 635 | 612 | 613 | 631 | 623 | 608 |
| 50% Modulus (psi) | 144 | 140 | 137 | 144 | 117 | 130 |
| 100% Modulus (psi) | 216 | 231 | 216 | 227 | 185 | 197 |
| 200% Modulus (psi) | 387 | 430 | 375 | 412 | 352 | 340 |
| 300% Modulus (psi) | 603 | 652 | 567 | 615 | 553 | 520 |

### Example 7

Effect of Lignin Moisture Content and Physical Form (Lignin Pellets and Powder) on Properties

In this Example the effect of lignin moisture content (bound and free water) as well as physical form (powder and pellet) on vulcanizate performance is presented and shown in Table 18. The carbon black reference compounds without lignin (EE and FF), have similar cure and tensile properties regardless of the moisture content. Even when increasing moisture contents up to 4 phr total loading, no difference in the performance was observed. By comparison, moisture content did have an impact on lignin-containing vulcanizate performance. Samples prepared with dry lignin (GG) performed comparable to that of the carbon black only samples (EE and FF). However, in the lignin containing samples an increase in physical properties was observed in the presence of moisture. Increasing the moisture content to 10 wt % (HH) improved tensile properties, particularly improving compound stiffness. This improvement in performance was maintained when the moisture content was further increased to 100 wt % (JJ). Similar performance was also observed for other lignin types (KK and LL).

Pelletization of the lignin (1-2 mm diameter pellet) did not impact performance, with the corresponding vulcanizate prepared using lignin pellets (II) performing as well as the powder form (HH). In some embodiments, ovoid pellets have been tested, with similar results, with the large dimension up to about 10 mm and the small dimension up to about 5 mm.

TABLE 18
Effect of lignin physical form
(pellets and powder) and moisture content on properties

| Compound | EE | FF | GG | HH | II | JJ | KK | LL |
|---|---|---|---|---|---|---|---|---|
| Lignin* | HKL | | | | | | SKL | OSL |
| Physical form | Powder | | | | Pellet | Powder | Powder | Powder |
| Lignin content (phr) | 0 | 0 | 8 | 8 | 8 | 8 | 8 | 8 |
| Moisture (wt %) | 0 | 4 | 0 | 10 | 10 | 100 | 25 | 12 |
| Moisture (total phr) | 0 | 1.6 | 0 | 0.8 | 0.8 | 8 | 2 | 0.96 |
| Delta torque (dNm) | 9.66 | 9.42 | 11.33 | 12.68 | 12.17 | 11.76 | 12.6 | 12.3 |
| Tensile strength (psi) | 1388 | 1463 | 1314 | 1466 | 1413 | 1334 | 1392 | 1403 |
| Elongation at break (%) | 627 | 629 | 628 | 612 | 597 | 518 | 549 | 608 |
| 50% Modulus (psi) | 141 | 132 | 128 | 140 | 138 | 154 | 139 | 135 |
| 100% Modulus (psi) | 212 | 205 | 207 | 231 | 228 | 281 | 240 | 222 |
| 200% Modulus (psi) | 380 | 377 | 377 | 430 | 431 | 534 | 481 | 426 |
| 300% Modulus (psi) | 587 | 598 | 566 | 652 | 653 | 775 | 741 | 650 |

*HKL = hardwood Kraft lignin;
SKL = softwood Kraft lignin;
OSL = organosolv lignin

### REFERENCES

Barana et al., (2018). ACS Sus. Chem. Eng.6 (9), 11843-11852.

Boonkerd et al., (2016) Rubber Chem. Tech. 89 (3), 450-464.

Botros et al., (2006). J. Appl. Pol. Sci. 99, 2504-2511.

Hu, T. Q. (2002). Chemical Modification, Properties, and Usage of Lignin, Springer, USA.

Ikeda et al., (2017). RSC Adv. 7, 5222-5231.

Kakroodi & Sain (2016). Lignin in Polymer Composites, Elsevier, 195-206.

Kosikova et al., (2005). J. Appl. Polym. Sci. 97, 924-929.

Kosikova et al., (2007). J. Appl. Polym. Sci. 103, 1226-1231.

Kruzelak & Hudec (2018) Rubber Chem Technol. 91(1) 167-183.

Kumaran et al., (1978). Polymer. 19, 461-463.

Kumaran and De, (1978). J. Appl. Polym. Sci. 22, 1885-1893.

Macfarlane, A. L., M. Mai and J. F. Kadla (2014). 20-Bio-based chemicals from biorefining: lignin conversion and utilisation. Advances in Biorefineries. K. Waldron, Woodhead Publishing: 659-692.

Matyjaszewski, K. (1996). Cationic Polymerizations: Mechanisms, Synthesis & Applications. New York, CRC Press.

Nando et al., (1980). J. Appl. Polym. Sci. 25, 1249-1252.

Nigam et al., (1998). Proc. 11^{th} National Symposium on Thermal Analysis, India p. 239.

Setua, et al., (2000). Polymer Composites. 21 (6), 988-995.

Valentin et al., (2010). Macromolecules. 43, 4210-4222.

JP2014184579.

U.S. Pat. No. 2,608,537.

U.S. Pat. No. 2,845,397.

U.S. Pat. No. 2,906,718.

U.S. Pat. No. 3,991,022.

U.S. Pat. No. 9,580,588B2.

US20100204368A1.

WO2009145784A1.

WO2014016344A1.

WO2014097108A1.

WO2015056758A1.

WO2017109672A1.

1. A lignin-reinforced vulcanizate comprising:
an elastomer comprising a synthetic halogenated poly(isobutene-co-isoprene) butyl rubber (XIIR), the XIIR being a copolymer of 95-99.5% isobutylene and 0.5-5% isoprene;
a co-reinforcing agent in a co-reinforcing concentration that increases the tensile strength of the vulcanizate compared to a reference vulcanizate, the co-reinforcing agent being carbon black or silica or a mixture thereof, and the co-reinforcing agent making up from 10-80 parts per hundred rubber (phr);
a lignin in a lignin concentration making up from 1-40 phr that increases crosslinking in the vulcanizate and:
increases one or more of the tensile strength, elongation at break, a tensile modulus, or crack growth resistance; and/or
decreases air permeability;
of the vulcanizate compared to the reference vulcanizate;
wherein the ratio of the lignin to the reinforcing agent is higher in the vulcanizate than in the reference vulcanizate, and the co-reinforcing concentration of the co-reinforcing agent in the vulcanizate is equal to or higher than a reference concentration of the co-reinforcing agent in the reference vulcanizate.

2. The lignin-reinforced vulcanizate of claim 1, wherein the vulcanizate comprises a phenolic component, and the lignin constitutes substantially all of the phenolic component of the vulcanizate.

3. The lignin-reinforced vulcanizate of claim 1, further comprising a filler that is a calcium carbonate, kaolin clay, talc, barite, or diatomite.

4. The lignin-reinforced vulcanizate of claim 1, wherein the co-reinforcing agent is carbon black, silica or a mixture of carbon black and silica.

5. The lignin-reinforced vulcanizate of claim 1, wherein the tensile modulus is a 50% tensile modulus, 100% tensile modulus, 200% tensile modulus, or 300% tensile modulus.

6. The lignin-reinforced vulcanizate of claim 1, wherein the elastomer comprises 98-99% isobutylene and 1-2% isoprene.

7. The lignin-reinforced vulcanizate of claim 1, wherein the lignin is derived in whole or in part from hardwood biomass, from softwood biomass or from annual fibre biomass.

8. The lignin-reinforced vulcanizate of claim 1, wherein the lignin is provided in a pelletized form.

9. The lignin-reinforced vulcanizate of claim 1, wherein the lignin contains between about 10 wt % and about 50 wt % moisture.

10. The lignin-reinforced vulcanizate of claim 1, wherein the co-reinforcing concentration of the co-reinforcing agent in the vulcanizate is equal to or higher than the reference concentration of the co-reinforcing agent in the reference vulcanizate.

11. A process for making a lignin-reinforced vulcanizate, comprising:
providing an elastomer comprising a halogenated poly(isobutene-co-isoprene) butyl rubber (XIIR), the XIIR being a copolymer of 95-99.5% isobutylene and 0.5-5% isoprene;
admixing the XIIR with a co-reinforcing agent and a lignin, wherein:
the co-reinforcing agent is provided in a co-reinforcing concentration that increases the tensile strength of the vulcanizate compared to a reference vulcanizate, the co-reinforcing agent being carbon black or silica or a mixture thereof, and the co-reinforcing agent making up from 10-80 parts per hundred rubber (phr);
the lignin is provided in a lignin concentration making up from 1-40 phr that increases crosslinking in the vulcanizate and:
increases one or more of the tensile strength, elongation at break, a tensile modulus, or crack growth resistance; and/or
decreases air permeability;
of the vulcanizate compared to the reference vulcanizate; wherein the ratio of the lignin to the reinforcing agent is higher in the vulcanizate than in the reference vulcanizate, and the co-reinforcing concentration of the co-reinforcing agent in the vulcanizate is equal to or higher than a reference concentration of the co-reinforcing agent in the reference vulcanizate; and,
adding an effective amount of a vulcanizing agent to the admixed XIIR, co-reinforcing agent and lignin, under reaction conditions that provide the lignin-reinforced vulcanizate.

12. The process of claim 11, wherein vulcanizate comprises a phenolic component, and the lignin constitutes substantially all of the phenolic component of the vulcanizate.

13. The process of claim 11, further comprising adding a filler that is a calcium carbonate, kaolin clay, talc, barite, or diatomite.

14. The process of claim 11, wherein the co-reinforcing agent is carbon black, silica or a mixture of carbon black and silica.

15. The process of claim 11, wherein the tensile modulus is a 50% tensile modulus, 100% tensile modulus, 200% tensile modulus, or 300% tensile modulus.

16. The process of claim 11, wherein the elastomer comprises 98-99% isobutylene and 1-2% isoprene.

17. The process of claim 11, wherein the lignin is derived in whole or in part from hardwood biomass, from softwood biomass or from annual fibre biomass.

18. The process of claim 11, wherein the lignin is provided in a pelletized form.

19. The process of claim 11, wherein the vulcanizate is formulated by direct mixing of the lignin with the XIIR, without co-precipitation of the lignin with the XIIR.

20. The process of claim 11, wherein the co-reinforcing concentration of the co-reinforcing agent in the vulcanizate is equal to or higher than the reference concentration of the co-reinforcing agent in the reference vulcanizate.
